(19) United States
(12) Patent Application Publication
(10) Pub. No.: US 2015/0266011 A1
(43) Pub. Date: Sep. 24, 2015

(54) Fluorinated Phthalocyanine-Solid-State Support Composites

(71) Applicants: Kimberly A. Griswold, Flanders, NJ (US); Sergiu M. Gorun, Montclair, NJ (US)

(72) Inventors: Kimberly A. Griswold, Flanders, NJ (US); Sergiu M. Gorun, Montclair, NJ (US)

(21) Appl. No.: 14/222,987

(22) Filed: Mar. 24, 2014

(51) Int. Cl. B01J 31/38

(52) U.S. Cl. CPC B01J 31/38

(57) ABSTRACT

A new class of hybrid composite materials, composites of a perfluoroalkyl fluoro phthalocyanine and a solid-state support—useful as heterogeneous catalysts for the degradation of organic molecules in aqueous systems via the photocatalytic generation of reactive oxygen species.

### FEDERAL RESEARCH STATEMENT

The invention described herein may be manufactured, used, and licensed by or for the U.S. Government for U.S. Government purposes.

### BACKGROUND OF INVENTION

1. Field of the Invention

The present invention relates to hybrid composites formed of a perfluorinated phthalocyanine, or mixtures thereof, and a solid-state support, or mixtures of such supports, including: various metal oxides, water insoluble salts, charcoal, clays, minerals, zeolites, metal particles and carbon clusters; and, more particularly, wherein such hybrid composites exhibit new and unique properties useful in various catalysis applications, such as photocatalysis based on reactive oxygen species (ROS) molecular bond breaking and catalysis to form new bonds.

2. Background Art

US Published Patent Application 2012/0283430, titled: “System and Method for Fluoroalkylated Fluoro phthalocyanines with Aggregating Properties and Catalytic Driven Pathway for Oxidizing Thiols”, to Sergiu M. Gorun et al, incorporated herein by reference, discloses phthalocyanine (Pc) materials, which materials are highly conjugated macrocycles known in the art, that belong to a group of photochemically active compounds that resemble porphyrins and chlorophylls (see FIG. 1 for a perfluoroalkyl metallo perfluoro phthalocyanine of the prior art). The 2012/0283430 publication discloses particular fluoroalkylated fluoro phthalocyanines that exhibit useful aerobic catalytic properties. Wherein, in general, a catalyst is a material which accelerates chemical reactions, while the catalyst itself is not affected by the particular reaction, i.e. the same mass of catalyst is present before and after the reaction. Effectively, a catalyst will provide an alternative route for the reaction, such that there is a lower activation energy—whereby, again, the reaction rate is accelerated.

Catalysts are often categorized as being homogenous or heterogeneous—where specifically: the catalyst is respectfully, in the same phase as the reactants (homogenous) or in a different phase (heterogeneous). Logically, and in practice, this means that homogenous catalysts, intimately mixed with the reactants, will generally provide higher chemical activity via lower effective activation energies; while, in contrast, heterogeneous catalysts will generally not exhibit such high chemical activity; but, are easily separated from the reactants, often just via a simple physical filtration. With respect to the phthalocyanine materials of interest—it is known that unsubstituted phthalocyanines, PcM, where M can be a metal or non-metal have low solubility in organic solvents and, therefore, will act as a heterogeneous catalyst in such solvents; substituted phthalocyanine, i.e. phthalocyanines containing additional atoms covalently linked to the organic macrocycle, such as fluorinated phthalocyanines that contain alkyl groups covalently linked to the phthalocyanine macrocycle, are significantly more soluble in such solvents and will tend to act as a homogenous catalyst—which creates a problem with separating such potentially useful materials from the desired products into which they are mixed.

While it is known in the art that various solid-state materials can be coupled with organic materials to form hybrid composites by providing a support joined to the organic molecules—such prior art composites generally contain C—H bonds that are unstable as part of the catalysts with respect to ROS. The ROS can react with the catalyst that produces them leading to deactivation. And, further, it is also known that particular solid-state materials potentially useful as supports, such as certain metal oxides, for example titanium oxides, may exhibit charge separation upon the addition of energy—via, for example, illumination. And, as a consequence of such charge separations, the solid-state support's surface centers exhibit free radical characteristics which should trigger chemical reactions that result in the decomposition of nearby (adsorbed) organic species, including supported organic molecules that have catalytic properties. Despite many investigations to-date, a need thus remains for new, stable/robust reactive materials that can catalyze the splitting of C—H bonds without self-decomposition, a process that eventually could lead to beneficial and effective removal of pollutants

Considering the above facts, there is a need in the art for strongly reactive and catalytically functional materials that are insoluble in organic solvents or aqueous solutions and thereby act as heterogeneous catalysts in such media, with the advantages thereof.

### SUMMARY OF INVENTION

The present invention provides a new class of organic-inorganic hybrid composite materials useful as new and improved heterogeneous catalysts able to degrade organic molecules—wherein, the organic portion of the hybrid composite is comprised of perfluoroalkyl fluoro phthalocyanines which can be represented as [FₓPcM(S_{y})ₙ], wherein M is a central metal, such as Zn, Co, Fe, Mg, Cu, and the like, or non-metal constituent, such as Si, P, or even hydrogen ions; x is a number greater than zero, and S_{y} is an axial ligand, neutral or charged, located or positioned with respect to the central metal/non-metallic atom, and n is an integer selected from 0, 1, 2, 3, and 4—such as, preferably, F₆₄PcZn; and, wherein, the inorganic portion of the hybrid composite is comprised of a solid-state material that is in contact with the organic portion as a support. Particular solid-state materials useful as supports in the present invention, include—(1) metal oxides, generally conforming to the chemical formulation of MₓO_{y}; (2) water insoluble salts, such as metal sulfides, carbonates, sulfates, halogenates, silicates, phosphates, chromates, and hydroxides; (3) inert complex materials, such as charcoal, clays, minerals, zeolites, metal particles and carbon clusters; and (4) mixtures of such metal oxides, water insoluble salts, and/or inert complex materials.

The inorganic-organic hybrid composite materials of the subject invention can be a combination of about 0.1 to about 1 weight percent of a perfluoroalkyl fluoro phthalocyanine or a mixture of phthalocyanines of the formulation detailed above, with about 99.9 to about 99 weight percent of the solid-state inorganic support, or a combination of such supports; more preferably, about 20 weight percent of the perfluoroalkyl fluoro phthalocyanine of the formulation detailed above, or mixtures thereof, and 80 weight percent of the solid-state inorganic support; and most preferably 5 weight percent of the perfluoroalkyl fluoro phthalocyanine of the formulation detailed above, or mixtures thereof, and about 95 weight percent of the solid-state inorganic support. Table 1, below, provides a more detailed listing of particularly preferred alternative solid-state supports useful in the present invention, categorized as metal oxides, water insoluble salts and inert complex materials useful; plus a detailing of the type of chemical bonding involved between each alternative solid-state support and the Pc material being supported.

TABLE 1
Alternative solid-state supports useful in the current invention.

| | | Interaction/Bonding Type |
|---|---|---|
| | | (Joining the particular type of |
| | Useful Examples of | solid-state support to perfluoro |
| Solid-state Support | Each Alternative | alkyl fluoro phthalocyanines, Pc) |
| Metal Oxide | Zn(II)O, Mg(II)O | Ranging from van der Waals |
| | Al(III)₂O₃ | interactions of fluorine Pc |
| | Si(IV)O₂, Ti(IV)O₂, | substituents, to van der Waals or |
| | Zr(IV)O₂ | coordinative bonding of surface |
| | | atoms to Pc metal or non-metal |
| | | centers |
| Water Insoluble Salts | Metal sulfides (S²⁻), carbonates | Ranging from van der Waals |
| | (CO₃²⁻), sulfates (SO₄²⁻), | interactions of fluorine Pc |
| | halogenates (Cl⁻, F⁻, etc.), | substituents to van der Waals or |
| | silicates (SiO₃²⁻, etc.), | coordinative bonding of surface |
| | phosphates (PO₄³⁻, etc.), | atoms to Pc metal or non-metal |
| | chromates (CrO₄²⁻), | centers |
| | hydroxides (HO⁻) | |
| Inert Complexing Material | Charcoal, clays, minerals, | Mostly van der Walls forces |
| | zeolites, metal particles, | |
| | carbon clusters | |

Considering the bonding detailed in Table 1 between the Pc material and the solid-state support, the composite phthalocyanine-solid state support defines a qualitatively new chemical material, i.e. a hybrid, which exhibits some properties, including chemical reactive strengths, not found in either of the two components. One surprising qualitative effect of these new chemical structures has been observed in the reaction rates of the composite F₆₄PcZn—TiO₂ embodiment of the present invention, which as detailed below, exhibits 4 times the reaction rate for the photo degradation of methyl orange vs. just the reaction rate of TiO₂. Unsupported F₆₄PcZn exhibits no reaction whatsoever, i.e. zero rate. It is, therefore, clear that the hybrid is the combination of two subject materials, which alone, exhibit zero or poor reactivity; that defines a qualitatively new composition of matter exhibiting new properties not exhibited by either component alone.

Additional features and advantages of the present invention are set forth in, or are apparent from, the drawings and detailed description thereof which follows.

### BRIEF DESCRIPTION OF DRAWINGS

FIG. 1 is a chemical representation of the general structural formula of substituted fluoro phthalocyanines useful in the present invention. R can stand for perfluoroalkyl groups, thus defining in this case the metallo perfluoro phthalocyanine type materials that are useful in combination with certain organic (such as carbon clusters, charcoal) or inorganic solid-state materials (such as oxides, etc.) as a component in the present invention.

FIG. 2 is a schematic representation of a hybrid composite of the present inventive phthalocyanine and solid-state support, in an aqueous medium, being exposed to air and light, such that the phthalocyanine and solid-state support acts as a catalyst in the formation of ROS.

FIG. 3 is a graph showing the decomposition effect over time of methyl orange dye—when subjected to solely the action of the solid-state support material TiO₂ as well as to the hybrid Pc and solid-state support composition (i.e. F₆₄PcZn and TiO₂) of the present invention.

### DETAILED DESCRIPTION

The present invention provides a new class of improved organic-inorganic hybrid composite materials useful as heterogeneous catalysts for the degradation of organic molecules via the photocatalytic generation of ROS in aqueous systems—wherein, the organic portion of the hybrid composite is comprised of a single perfluoroalkyl fluoro phthalocyanine, or mixtures thereof, which can be represented as [FₓPcM(S_{y})ₙ], wherein M is a central metal, such as Zn or other metal with an ionic radii that can be coordinated by the four nitrogen atoms of the phthalocyanine, e.g. Co, Fe, Mg, Cu, and the like, or a non-metal constituent, such as Si, P, or even a hydrogen ion; x is a number greater than zero, and S_{y} is an axial ligand, neutral, or charged located or positioned with respect to the central metal/non-metallic atom, or combinations of axial ligands and n is an integer selected from 0, 1, 2, 3, and 4 such as, preferably, F₆₄PcZn; and, wherein, the inorganic portion of the hybrid composite is comprised of a solid-state material that is in bonding contact with the organic portion as a support. Particular solid-state materials useful as supports in the present invention, include—(1) metal oxides, generally conforming to the chemical formulation of MₓO_{y}; (2) water insoluble salts, such as metal sulfides, carbonates, sulfates, halogenates, silicates, phosphates, chromates, and hydroxides; (3) inert complex materials, such as charcoal, clays minerals, zeolites, carbon clusters, and the like; and (4) mixtures of such metal oxides, water insoluble salts, and/or inert complex materials. The metal oxides conforming to the chemical formulation of MₓO_{y}, include those wherein: M=Zn, Cu, Mg, Si, Ti, Al, Zr and similar atoms; while x and y are stoichiometric coefficients needed to generally render the particular material electrically neutral. Particularly useful oxides exhibiting such general charge neutrality, may include M=Al and x=2 and y=3; and, M being Si, Ti, or Zr and x=1 and y=2; and M being Zn, Cu, or Mg and x=1 and y=1.

Importantly, when the organic perfluoroalkyl fluoro phthalocyanine moieties of the molecules of the present invention are contacted with a solid-state support useful in the present invention, new bonding develops between the Pc material and the solid-state support, bonds that cannot exist in the absence of this particular combination. Similarly, the metal or non-metal center of the phthalocyanine interacts with the surface atoms of the support. Thus, the phthalocyanine-solid state support composite forms a qualitatively new material, a hybrid, that exhibits some properties not found in either of the two components. For example, compounds of the present invention offer significant advantages relative to prior art as catalyst systems with respect to the decontamination of water.

The general formula for the oxides and salts useful in the present invention is (Cation)ₘ(Anion)ₙ, wherein the “m” and “n” are integers, and the overall charge of the oxide or salt is zero. Useful examples include metal salts with anions belonging to (i) group 7 of the Periodic Table, for example halogen ions, their oxo-anions, and the like; (ii) group 6 of the Periodic Table, for example sulfates, sulfites, sulfides, sulfonates, and the like; (iii) group 5 of the Periodic Table, for example nitrates, nitrites, phosphates, and the like; (iv) group 4 of the Periodic Table, for example carbonates, silicates, and the like; (v) group 3 of the Periodic Table, for example borates, aluminates, and the like. Further, other useful examples included are combination of metals and anions, i.e. mixed salts. And, importantly, a key characteristic of any such potential solid-state supporting material, useful in the present invention, is that such materials must not be soluble in the organic solutions useful in the manufacture of the subject hybrid materials of the present invention (as detailed below) or soluble in the aqueous solutions in which the composite materials are used. Therefore, any particular salts, or oxides, or inert complexes useful as solid-state supports cannot be soluble—in either certain organic or aqueous mixtures. For example, the solubility constant, Kₛₚ, for the particular salts useful in the present invention must be small, i.e. such that the salt does not significantly ionize in the subject solvents. Particularly useful insoluble salts and their respective Kₛₚ in water include: AgBr—5×10⁻¹³; BaCO₃—2×10⁻⁹; CaCO₃—5×10⁻⁹; Hg₂Cl₂—1×10⁻¹⁸; PbCl₂—1.7×10⁻⁵; Ag₂CrO₄—2×10⁻¹²; BaCrO₄—2×10⁻¹⁰, PbCrO₄—1×10⁻¹⁶, BaF₂—2×10⁻6; CaF2—2×10⁻¹⁰, PbF₂—4×10⁻⁸, Al(OH)₃—5×10³³, Cr(OH)₃—4×10⁻³⁸, Fe(OH)₂—1×10⁻¹⁵, Fe(OH)₃—5×10⁻³⁸, Mg(OH)₂—1×10⁻¹¹, Zn(OH)₂—5×10⁻¹⁷, PbSO₄—1×10⁻⁸, CdS—1×10²⁶, CoS—1×10⁻²⁰, CuS—1×10⁻³⁵, FeS—1×10⁻¹⁷, HgS—1×10⁻⁵², MnS—1×10⁻¹⁵, ZnS—1×10⁻²⁰.

In addition to the above, some salts may contain a neutral molecule, such as those that can solvate the cations, for example, ammonia, NH₃, and it should be understood that such solvates are included in the above definition of useful “cation” or “anion” materials in the present invention as solid-state supports. And, furthermore, neutral molecules or materials composed of atoms can be used as supports—for example the above detailed inert complex materials—such as charcoal, graphite, carbon clusters, and/or metal particles. Moreover, useful materials include those that exhibit internal voids—for example, zeolites or clays—voids that, when contacted with the subject organic Pc materials, could be filled by them partially or fully. And, as a result, the Pc material will be trapped in an environment that brings in close proximity the substrate and the catalysts and thus induces the desired catalytic specificity properties to the overall hybrid composition.

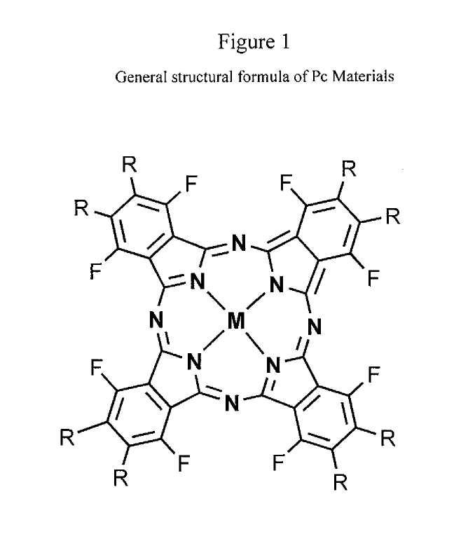

Particular perfluoroalkyl groups, R, FIG. 1, that may be advantageously incorporated into the disclosed organic perfluoroalkyl fluoro-phthalocyanine compounds useful in the present invention include, but are not limited, to perfluoroisopropyl, perfluoropentyl, perfluorohexyl, perfluorooctyl, and isomers and/or combinations thereof. Moreover, the aforementioned perfluoroalkyl groups may contain additional groups, for example, fluorinated aromatic molecules. Perfluoroalkyl groups comprising 3 carbon atoms are particularly effective for covalently bonding to the periphery of metallo fluoro-phthalocyanines according to the present disclosure. An exemplary perfluoroalkyl group with 3 carbon atoms that may be incorporated as part of the disclosed catalytic compound is perfluoro isopropyl.

To aid in the understanding of the subject invention, the following examples are provided as illustrative thereof; however, they are merely examples and should not be construed as limitations on the claims:

### Example 1

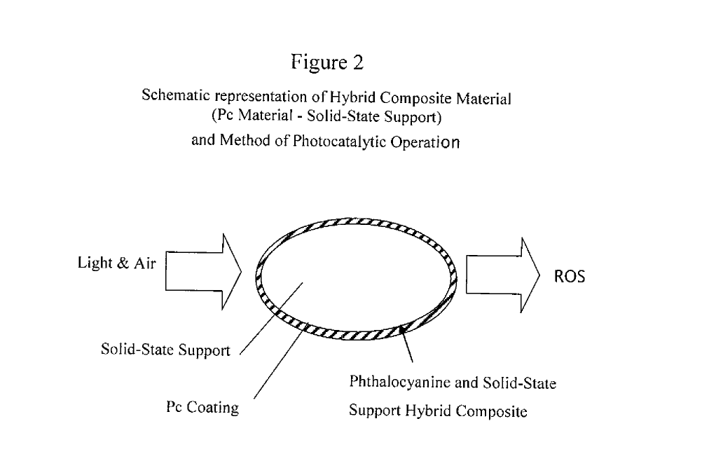

A perfluoro phthalocyanine FₓPcM(S_{y})ₙ, with x=64, M=Zn and n=0 (F₆₄PcZn) preferred as the organic constituent, in the organic-inorganic hybrid composite materials of the present invention, was prepared following a literature procedure disclosed in “Introduction of Bulky Perfluoroalkyl Groups at the Periphery of Zinc Perfluoro Phthalocyanine: Chemical, Structural, Electronic, and Preliminary Photophysical and Biological Effects,” B. Bench, A. Beveridge, W. Sharman, G. Diebold, J. van Lier, S. M. Gorun, Angew. Chem. Int. Ed, 41, 748, 2002 which complete article is incorporated herein by reference. The resulting F₆₄PcZn material was dissolved in an organic solvent, such as ethanol or acetone, and mixed vigorously with a finely powdered solid-state MₓO_{y} oxide, preferably, where M=Si, or more preferably where M=Ti and x=1 and y=2 (i.e. SiO₂ or TiO₂). The slurry was evaporated to remove the solvents and the resulting blue-green hybrid material was dried at 100° C. for 12 hours—forming a fine powder. The resulting hybrid composite material contained about 1% by weight phthalocyanine and about 99% by weight metal oxide. FIG. 2 presents schematically the hybrid composition and photocatalytic principle of its operation via the formation of reactive oxygen species with light—which reactive oxygen species (ROS) are capable of degrading undesired organic contaminants.

### Example 2

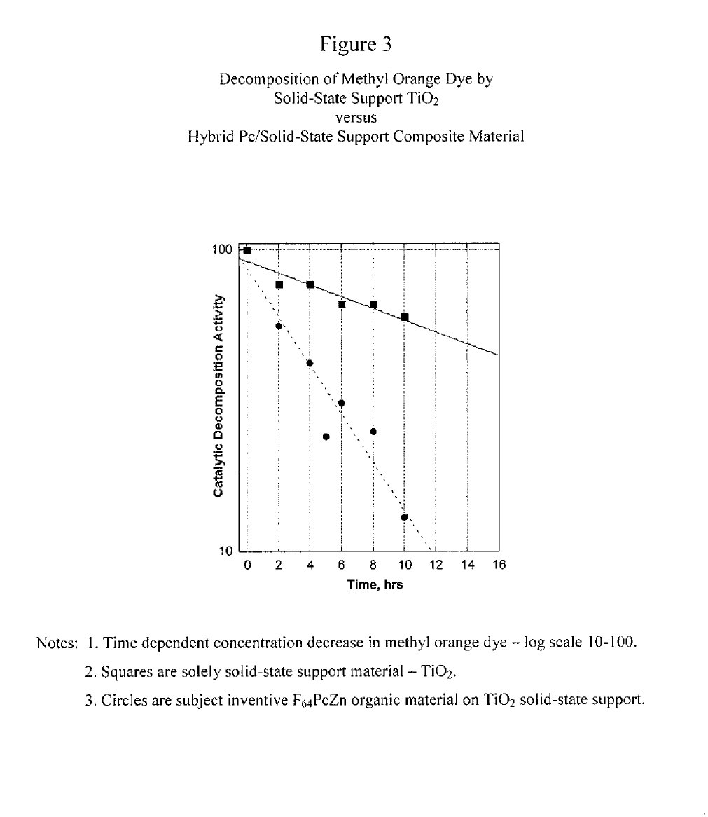

Using the procedure of Example 1, a quantity of the F₆₄PcZn—Ti02 embodiment of the present invention was prepared as a fine powder and about 1 gram thereof was added to 50 ml of a yellow/orange colored methyl orange solution. The suspension of the F₆₄PcZn—TiO₂ fine powder in the yellow/orange colored methyl orange solution was irradiated with white light and air was bubbled in—as schematically shown in FIG. 3—such that ROS were generated resulting in the degradation of the methyl orange and thereby the removal the color from the subject solution. This experiment was repeated using the same conditions and quantities—but replacing the F₆₄PcZn—TiO₂ embodiment with solely 1 gram of finely powdered TiO₂. As shown in FIG. 3, after about 10 hours the F₆₄PcZn—TiO₂ embodiment had removed over 90% of the methyl orange contaminant—while the TiO2 alone, in contrast, had failed to remove about 75% thereof (as measured using quantitatively using UV-Vis spectrophotometry). Additionally, a suspension of the Pc alone, over the same 10 hour period had removed virtually none of the methyl orange contaminant. Therefore, the relative rate of the F₆₄PcZn—TiO₂ embodiment (in providing ROS to degrade and remove the methyl orange) was almost 4 times that of the TiO₂ and the relative rate of the F₆₄PcZn alone was 0.

### Example 3

Using the procedure of Example 1, a quantity of the F₆₄PcZn—TiO₂ embodiment of the present invention was prepared as a fine powder and about 1 gram thereof was added to 50 ml of water to form an aqueous suspension. This suspension was mixed with an excess of anthracene-9,10-bis(vinyl sulfonate), sodium salt (AVS), a known singlet oxygen trap and subsequently subjected to light. As the F₆₄PcZn—TiO₂ generated singlet—oxygen, a ROS, the AVS trapped the singlet oxygen to form the endoperoxide AVSO₂. The conversion was monitored via UV-Vis spectroscopy. The first order kinetics of the reaction was demonstrated by the linearity of a plot of the absorption of AVSO₂ on a log y-axis vs. the time on the x-axis. This example demonstrates unambiguously the formation of ROS by the F₆₄PcZn—TiO₂ embodiment of the present invention.

Although the subject invention has been described above in relation to embodiments thereof, it will be understood by those skilled in the art that variations and modifications can be effected in these preferred embodiments without departing from the scope and spirit of the invention.

We claim:

1. A hybrid composite material comprised of:
an organic perfluoroalkyl fluoro phthalocyanine of the form FₓPcM(S_{y})ₙ;
wherein M is a central metal or non-metal constituent; x is a number greater than zero, and S_{y} is an axial ligand, neutral, or charged located or positioned with respect to the central metal/non-metallic atom, and n is an integer selected from 0, 1, 2, 3, and 4; and
a solid-state support, or a mixture of solid-state supports;
whereby the perfluoroalkyl fluoro phthalocyanine and the solid state support form a hybrid composite material that exhibits photocatalytic properties.

2. The hybrid composite material of claim 1, wherein the solid-state support is selected from the group consisting of (1) MₓO_{y} metal oxides; (2) water insoluble salts, such as metal sulfides, carbonates, sulfates, halogenates, silicates, phosphates, chromates, and hydroxides; (3) inert complex materials, inorganic or organic, such as charcoal, clays minerals, zeolites, carbon clusters, and the like; and (4) a mixture of such materials.

3. The hybrid composite material of claim 2, wherein the solid-state support is a metal oxide having the chemical formula of MₓO_{y}; wherein M=Zn, Cu, Mg, Si, Ti, Al, Zr; and x and y are stoichiometric coefficients needed to generally render the particular material electrically neutral.

4. The hybrid composite material of claim 2, wherein the solid-state support is a metal oxide having the chemical formula of MₓO_{y}; wherein M is Al and x=2 and y=3.

5. The hybrid composite material of claim 2, wherein the solid-state support is a metal oxide having the chemical formula of MₓO_{y}; wherein M is Si, Ti, or Zr and x=1 and y=2.

6. The hybrid composite material of claim 2, wherein the solid-state support is a metal oxide having the chemical formula of MₓO_{y}; wherein M is Zn, Cu, or Mg and x=1 and y=1.

7. The hybrid composite material of claim 1, wherein the organic perfluoroalkyl fluoro phthalocyanine material is a mixture of one or more materials of the form FₓPcM(S_{y})ₙ, wherein M is a central metal or non-metal constituent; x is a number greater than zero, and S_{y} is an axial ligand, neutral, or charged located or positioned with respect to the central metal/non-metallic atom, and n is an integer selected from 0, 1, 2, 3, and 4.

8. The organic-inorganic hybrid composite material of claim 1, wherein the weight percentage of the an organic perfluoroalkyl fluoro phthalocyanine is about 0.1 to about 1 weight percent and the weight percent of the solid-state inorganic support is about 99 to about 99.9 weight percent.

9. The hybrid composite material of claim 1, wherein the weight percentage of an organic perfluoroalkyl fluoro phthalocyanine is about 1 weight percent and the weight percent of the solid-state inorganic support is about 99 weight percent.

10. The organic-inorganic hybrid composite material of claim 1, wherein the weight percentage of an organic perfluoroalkyl fluoro phthalocyanine is about 5 weight percent and the weight percent of the solid-state inorganic support is about 95 weight percent.

11. The hybrid composite material of claim 1, wherein the weight percentage of an organic perfluoroalkyl fluoro phthalocyanine is about 20 weight percent and the weight percent of the solid-state inorganic support is about 80 weight percent.

12. The hybrid composite material of claim 1, wherein the perfluoroalkyl is selected from the group consisting of perfluoroisopropyl, perfluoropentyl, perfluorohexyl, perfluorooctyl, and isomers thereof or combinations thereof.

13. The hybrid composite material of claim 1, wherein organic perfluoroalkyl fluoro phthalocyanine is F₆₄PcZn.

14. The hybrid composite material of claim 1, wherein organic perfluoroalkyl fluoro phthalocyanine is F₆₄PcZn and the solid-state support is TiO₂.
